(19) United States
(12) Patent Application Publication
(10) Pub. No.: US 2016/0082655 A1
(43) Pub. Date: Mar. 24, 2016

(54) IMPROVED STEREOLITHOGRAPHY SYSTEM

(71) Applicants: Diego CASTANON, North Vancouver (CA); Jeff SNIDER, Langley (CA)

(72) Inventors: Diego Castanon, Burnaby (CA); Jeff Snider, Langley (CA)

(21) Appl. No.: 14/888,931

(22) PCT Filed: May 5, 2014
(86) PCT No.: PCT/CA2014/050428

§ 371 Date: Nov. 3, 2015

Related U.S. Application Data
(60) Provisional application No. 61/819,493, filed on May 3, 2013.

(51) Int. Cl. B29C 67/00; B29C 35/08

(52) U.S. Cl. CPC B29C 67/0066; B29C 35/0805; B29C 2035/0827; B33Y 30/00

(57) ABSTRACT

A stereolithography system comprises a first emitting device, a second emitting device, and a tank disposed between the first emitting device and the second emitting device. The stereolithography system may further include a drip feeder in fluid communication with the tank. The first emitting device, the second emitting device, and the tank may be aligned either horizontally or vertically.

### BACKGROUND OF THE INVENTION

1. Field of the Invention

The present invention relates to a stereolithography system and, in particular, to a stereolithography system with two emitting devices.

2. Description of the Related Art

U.S. Pat. No. 4,575,330 which issued on Mar. 11, 1986 to Hull, and the full disclosure of which is incorporated herein by reference, discloses a stereolithography system for forming a three-dimensional object by creating a cross-sectional pattern of the object to be formed at a selected surface of a fluid medium capable of altering its physical state in response to appropriate synergistic stimulation by impinging radiation, particle bombardment or chemical reaction. Successive adjacent laminae, representing corresponding successive adjacent cross-sections of the three-dimensional object, are automatically formed and integrated together to provide a step-wise laminar formation of the desired object. The three-dimensional object is formed and drawn from a substantially planar surface of the fluid medium during the stereolithography process.

Conventional stereolithography systems generally comprises a tank configured to contain a fluid medium (e.g. resin), an emitting device for emitting synergistic stimulation to alter the physical state of the fluid medium, or resin, and a support surface upon which the three-dimensional object is formed. The support surface is disposed in the tank and faces the emitting device. There is also an actuator which moves the support surface within the tank, towards the emitting device, in a direction that is substantially orthogonal to a bottom of the tank. The stereolithography system accordingly forms successive adjacent cross-sections of the three-dimensional object step-wise in a vertical direction.

### SUMMARY OF THE INVENTION

It is an object of the present invention to provide an improved stereolithography system.

There is accordingly provided a stereolithography system comprising a first emitting device, a second emitting device, and a tank disposed between the first emitting device and the second emitting device. The stereolithography system may further include a drip feeder in fluid communication with the tank. The first emitting device, the second emitting device, and the tank may be aligned either horizontally or vertically.

An embodiment of the stereolithography device comprises a first emitting device, a second emitting device, and a tank disposed between the first emitting device and the second emitting device. The tank includes a first moveable partition and a second moveable partition which define a central chamber of the tank. A drip feeder is in fluid communication with and provides resin to the central chamber of the tank. There may be a carrier element disposed within the central chamber of the tank.

The first moveable partition and the second moveable partition may each be moveable step-wise from innermost positions to outermost positions. The first emitting device may be moveable step-wise in tandem with or independently of the first moveable partition. The second emitting device may be moveable step-wise in tandem with or independently of the second moveable partition. A cross-section of an article may be formed on both sides of the carrier element when first emitting device moves step-wise in tandem with or independently of the first moveable partition then emits a blast, and the second emitting device moves step-wise in tandem with or independently of the second moveable partition then emits a blast. The carrier element may be an absorbent carrier element or a non-absorbent carrier element. There may be a smaller tank within the tank. The tank may have removable side walls. The tank may further include a cover which blocks extraneous UV light. The tank may be coated in polytetrafluoroethylene.

The first moveable partition may alternatively remain stationary and the second moveable partition may be moveable step-wise from an innermost position to an outermost position. The second emitting device may be moveable step-wise in tandem with or independently of the second moveable partition. A cross-section of an article may be formed on an inner surface of the first partition when the second emitting device moves step-wise in tandem with or independently of the second moveable partition then emits a blast.

### BRIEF DESCRIPTIONS OF DRAWINGS

The invention will be more readily understood from the following description of the embodiments thereof given, by way of example only, with reference to the accompanying drawings, in which:

FIG. 1 is a perspective view of an improved stereolithography system;

FIG. 2 is a perspective view of a tank of the stereolithography system of FIG. 1;

FIG. 3 is a cross-sectional view of the tank shown in FIG. 2;

FIG. 4 is a perspective view of the stereolithography system of FIG. 1 showing moveable partitions thereof at an innermost position;

FIG. 5 is a perspective view of the stereolithography system of FIG. 1 showing moveable partitions thereof at an intermediate position;

FIG. 6 is a perspective view of the stereolithography system of FIG. 1 showing moveable partitions thereof at an outermost position;

FIG. 7 is a perspective view of the stereolithography system of FIG. 1 showing the tank of FIG. 2 without side walls;

FIG. 8 is a perspective view of the stereolithography system of FIG. 1 showing an article being formed on a carrier element thereof;

FIG. 9 is a perspective view of the stereolithography system of FIG. 1 showing an article being formed on inner surface of a moveable partition thereof;

FIG. 10 is a view of the stereolithography system of FIG. 1 showing a smaller tank within the tank of FIG. 2.

### DESCRIPTIONS OF THE PREFERRED EMBODIMENTS

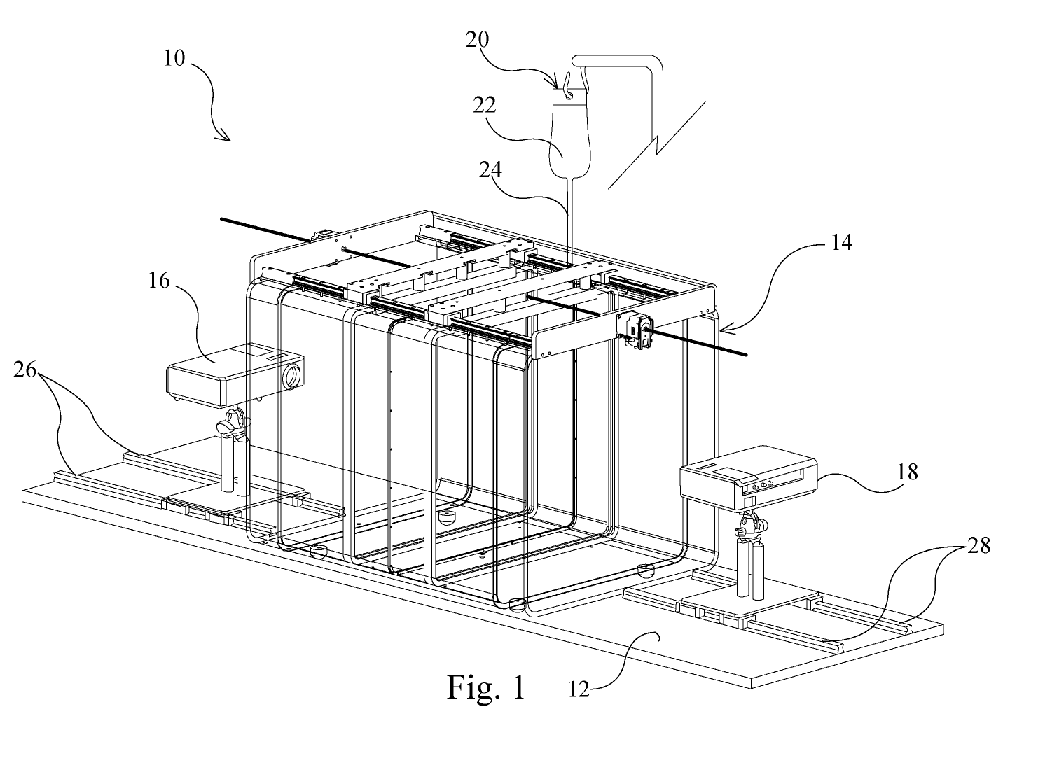

Referring to the drawings and first to FIG. 1, there is shown an improved stereolithography system 10 which general comprises a platform 12 that supports a tank 14, a first emitting device 16, and a second emitting device 18. There is also a drip feeder 20 in fluid communication with the tank 14. The drip feeder 20 includes a reservoir 22 filled with a resin and a conduit 24 which extends from the reservoir 22 into the tank 14. The tank 14 is maintained in a fixed position on platform 12 while the first emitting device 16 and the second emitting device 18 are each mounted on respective linear guides 26 and 28 to allow movement of the emitting devices relative to the tank. In this example, the emitting devices are DLP® projectors, manufactured by Texas Instruments Incorporated of 12500 TI Boulevard, Dallas, Tex. 75243 USA, with the UV filter and color wheel removed. However, in other examples, other suitable emitting device may be used.

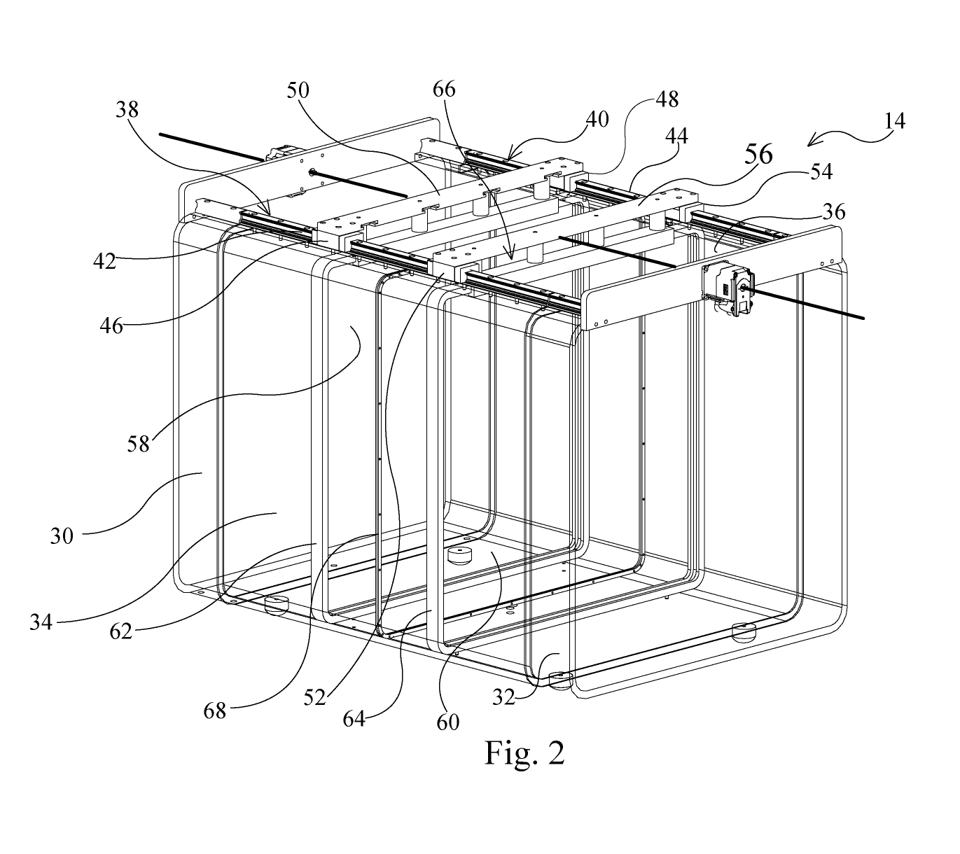

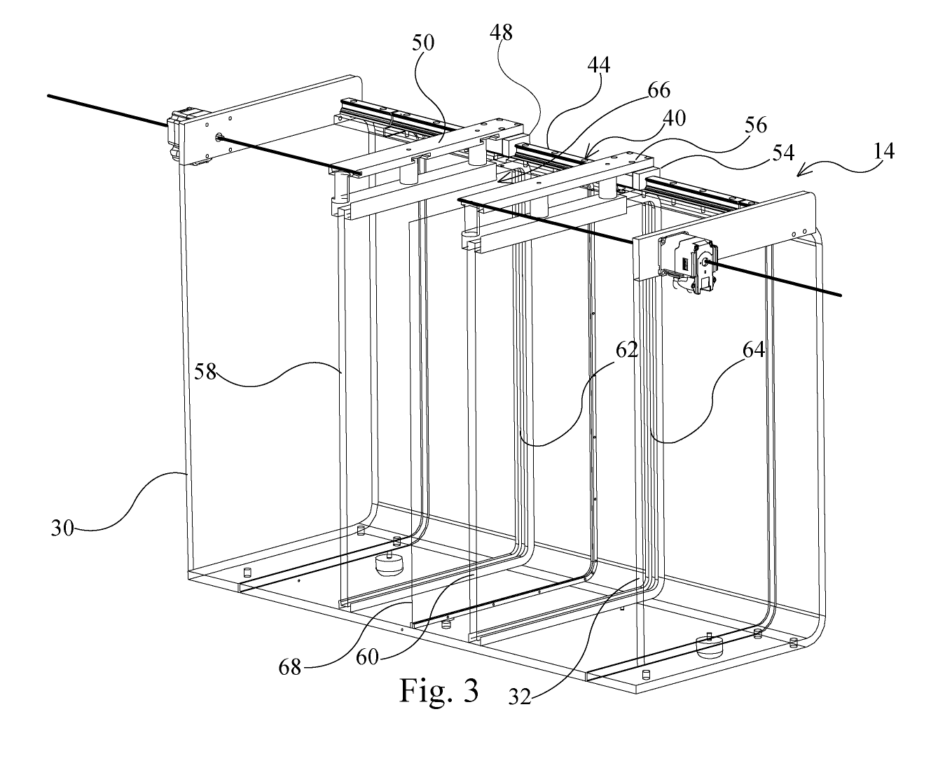

The tank 14, which is shown in greater detail in FIGS. 2 and 3, includes end portions 30 and 32 which are fixedly mounted on the platform 12 (shown in FIG. 1). Opposed side walls 34 and 36 extend between the end portions 30 and 32. The side walls 34 and 36 are releasably connected to the platform 12 and the end portions 30 and 32. There are linear guides 38 and 40 which are each mounted on corresponding ones of the side walls 34 and 36. The linear guides 38 and 40 each include a respective sliding track 42 and 44. Respective first sliding blocks 46 and 48 of linear guides 38 and 40 are coupled by a first linking arm 50. Likewise, respective second sliding blocks 52 and 54 of respective linear guides 38 and 40 are coupled by a second linking arm 56. A first partition 58 hangs from the first linking arm 50 and a second partition 60 hangs from the second linking arm 56. The first partition 58 and the second partition 60 are translucent panels that are each provided with a respective peripheral seal 62 and 64 which respectively seal the first partition 58 and the second partition 60 against the side walls 34 and 36 of the tank 14. Accordingly, the first partition 58 and the second partition 60 define a partially sealed central chamber 66 of the tank 14. In this example, there is a carrier element 68 disposed in the central chamber 66 of the tank 14 but this may not be required. The drip feeder 20, shown in FIG. 1, is in fluid communication with the central chamber 66 of the tank 14.

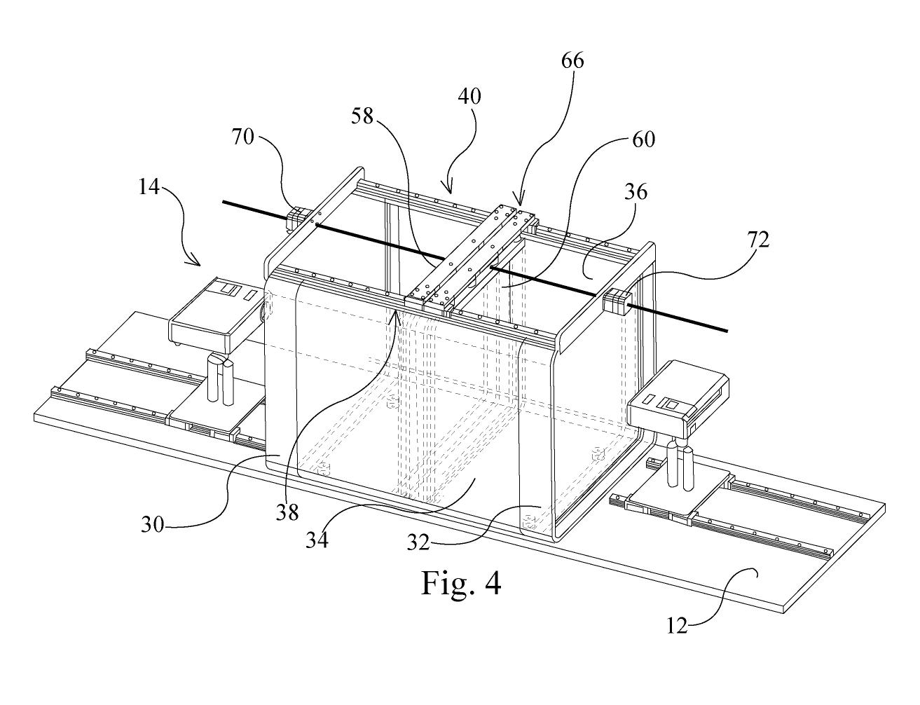

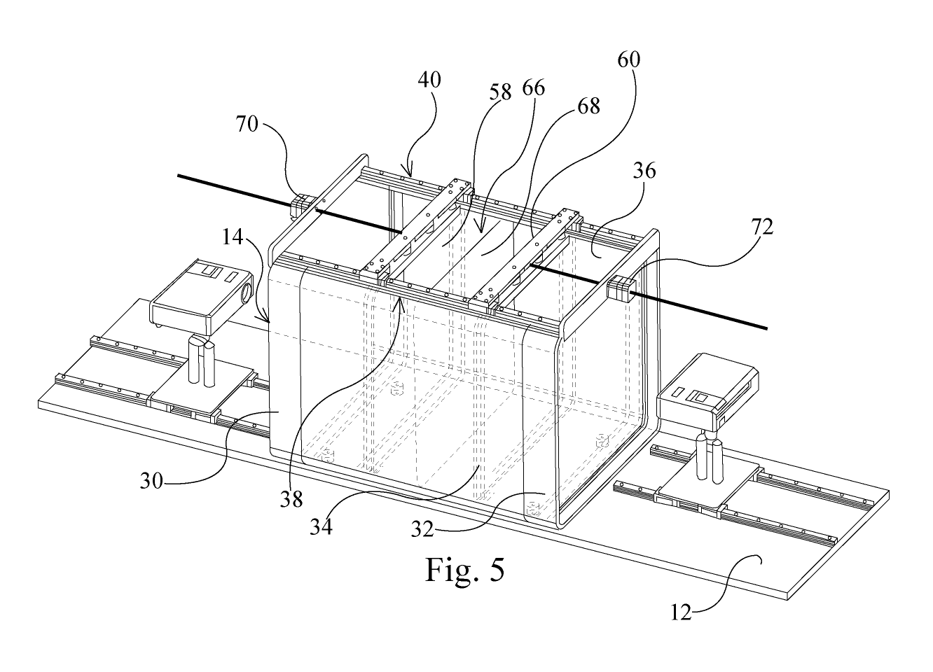

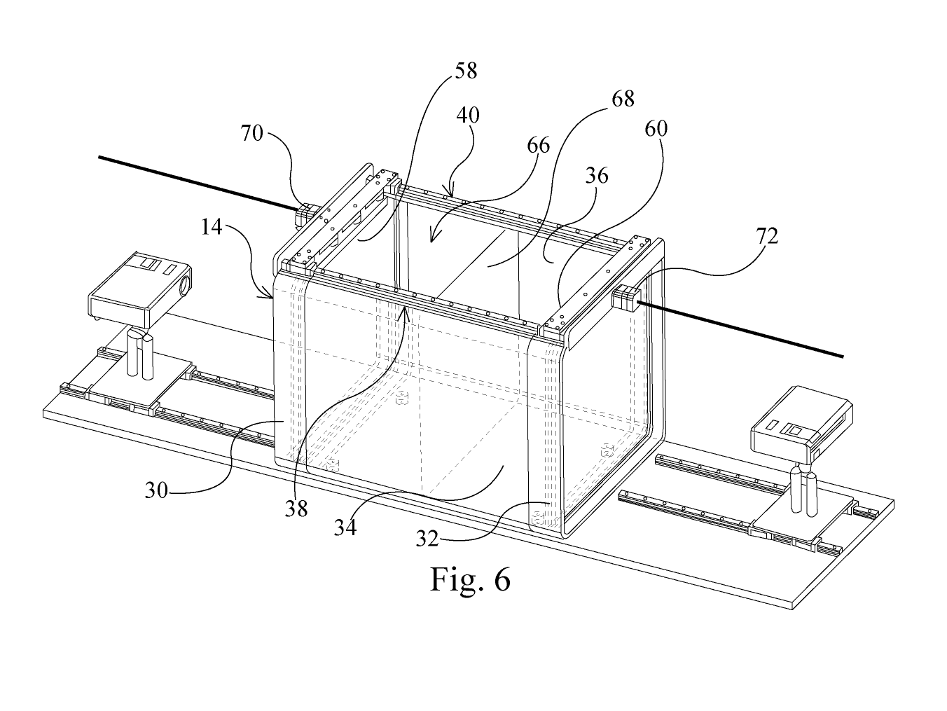

Referring now to FIGS. 4 to 6, the first partition 58 and the second partition 60 are independently slidable, or moveable, along the linear guides 38 and 40. Respective actuators, spindle drives 70 and 72 in this example, are used to move the first partition 58 and the second partition 60 and thereby dynamically and selectively change the size of the central chamber 66 of the tank 14. FIG. 4 shows the first partition 58 and the second partition 60 at innermost positions within the tank 14. FIG. 5 shows the first partition 58 and the second partition 60 at intermediate positions within the tank 14. FIG. 6 shows the first partition 58 and the second partition 60 at outermost positions within the tank 14. It will be understood by a person skilled in the art that the first partition 58 and the second partition 60 may be selectively moved between their innermost positions, shown in FIG. 4, and their outermost positions shown in FIG. 6.

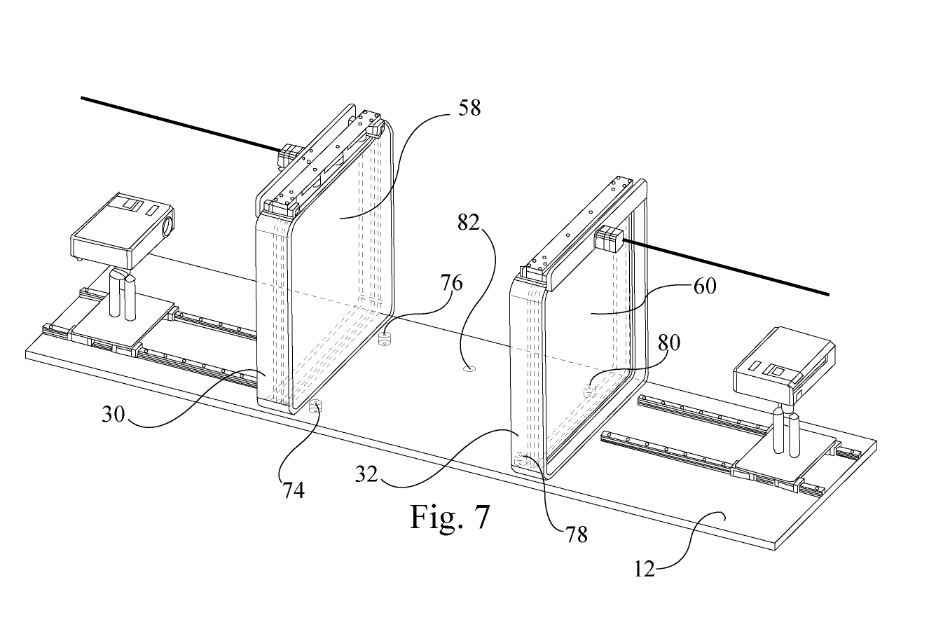

At their outermost positions, the first partition 58 and the second partition 60 are received by a corresponding one of the end portions 30 and 32. This allows the side walls 34 and 36 to be removed, as shown in FIG. 7, to facilitate cleaning. The tank 14 may also be coated with Teflon® (polytetrafluoroethylene) to facilitate cleaning. FIG. 7 shows a plurality of guide recesses 74, 76, 78 and 80 in the platform 12 which ensure that the side walls 34 and 36 are properly positioned when mounted on the platform 12. FIG. 7 also shows an outlet 82 of the tank 14 which, in this example, is a through hole in the platform 12.

In operation, the first partition 58 and the second partition 60 are moved to their innermost positions and the central chamber 66 of the tank 14 is filled with resin to a desired level. The desired level of resin will generally correspond to a height of an article being formed and is set by selectively positioning an outlet (not shown) of the drip feeder 20 within the central chamber 66 of the tank 14. The drip feeder 20 is then used to fill the central chamber 66 of the tank 14 with resin until a level of resin corresponds to the position of the outlet (not shown) of the drip feeder 20 within the tank 14. The first emitting device 16 and the second emitting device 18 then emit a blast of UV light which causes the formation of adjacent inner cross-sections of an article being on either side of the carrier element 68. The carrier element may be an absorbent carrier element which is absorbed during the stereolithographic process when the adjacent inner cross-sections on either side of the carrier element are formed and integrated together in response to the initial UV blast. Alternatively, the carrier element may be non-absorbent in which case the portions of the article formed on opposite side of non-absorbent carrier element would have to later be bonded. A non-absorbent carrier element may be useful when forming different shapes of an asymmetrical article on opposite sides of the carrier element or different articles on opposite sides of the carrier element. Still alternatively, a carrier element may not be required and an article may be formed on an inner side of the first partition or the second partition.

Following the formation of the adjacent inner cross-sections on either side of the carrier element 68, the first partition 58 and the second partition 60 are moved step-wise from their innermost position towards their outermost position. A UV blast is emitted by the first emitting device 16 and the second emitting device 18 following each step-wise movement of the first partition 58 and the second partition 60. Each UV blast causes the formation of a cross-section of the article being formed. The article is accordingly formed step-wise in an outwardly direction. The first emitting device 16 and the second emitting device 18 move step-wise along their respective linear guides 26 and 28 and in tandem with or independently of the first partition 58 and the second partition 60 to maintain a constant focus distance. Movement of the partitions and emitting devices may be controlled by a controller (not shown).

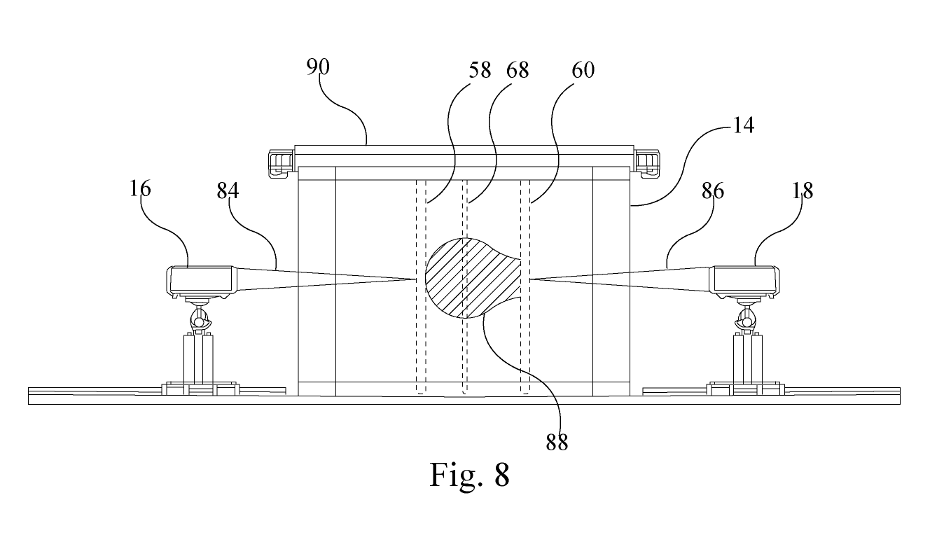

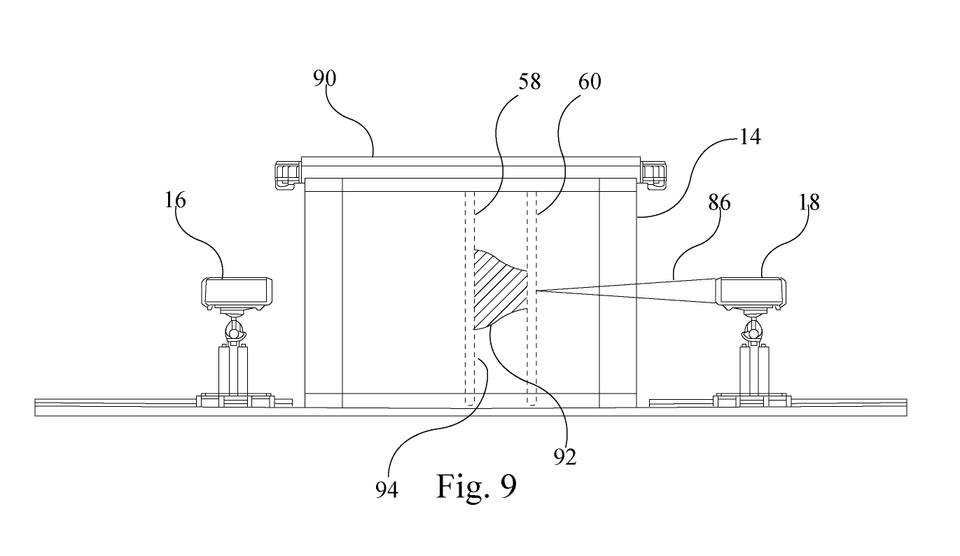

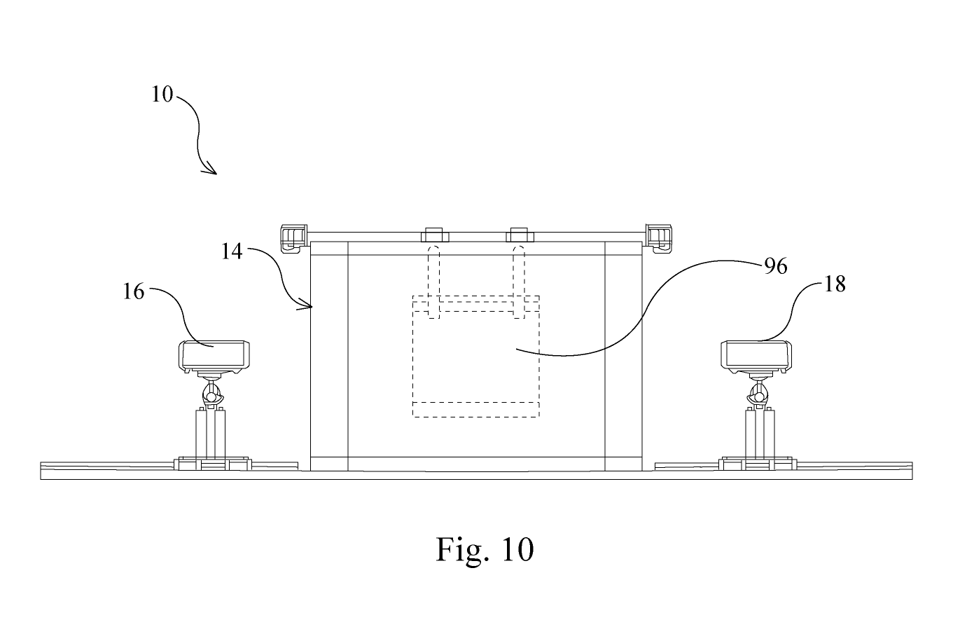

FIG. 8 shows UV blasts 84 and 86 causing the formation of cross-sections of an article 88 being formed on either side of the carrier element 68. In FIG. 8, the tank 14 is further provided with a cover 90 which, in this example, functions to block extraneous UV light. FIG. 9 shows a UV blast 86 causing the formation of cross-sections of an article 92 being formed on an inner surface 94 of the first partition 58. In FIG. 9, the first partition 58 remains stationary as the second partition 60 and second emitter 18 move step-wise, in tandem or independently, as the article 92 is being formed. FIG. 10 shows a smaller tank 96 within the tank 14. The smaller tank 96 has a similar structure to the tank 14 and may be used to form smaller articles in a manner as described herein for the tank 14. The smaller tank may therefore eliminate the need to acquire numerous stereolithography systems of differing sizes.

The stereolithography system shown in FIGS. 1 to 10 shows the tank and the emitting devices in horizontal alignment. However, in alternative embodiments of the stereolithography system, the tank and the emitting devices may be in vertical alignment in a double elevator system. The stereolithography system shown in FIGS. 1 to 9 has two emitting devices. However, in alternative embodiments of the stereolithography system, a single emitting device may be used with a UV blast splitter such as a mirror or prism to split the UV blast to form at least two sections of the articles being formed.

It will be understood by a person skilled in the art that many of the details provided above are by way of example only, and are not intended to limit the scope of the invention which is to be determined with reference to the following claims.

What is claimed is:

1. A stereolithography system comprising:
a first emitting device;
a second emitting device;
a tank disposed between the first emitting device and the second emitting device, the tank including a first moveable partition and a second moveable partition which define a central chamber of the tank; and
a drip feeder in fluid communication with and providing resin to the central chamber of the tank.

2. The stereolithography system as claimed in claim 1 wherein the first moveable partition and the second moveable partition are each moveable step-wise from innermost positions to outermost positions.

3. The stereolithography system as claimed in claim 1 or 2 wherein the first emitting device is moveable step-wise in tandem with the first moveable partition and the second emitting device is moveable step-wise in tandem with the second moveable partition.

4. The stereolithography system as claimed in claim 1 or 2 wherein the first emitting device is moveable step-wise independently of the first moveable partition and the second emitting device is moveable step-wise independently of the second moveable partition.

5. The stereolithography system as claimed in claim 1 further including a carrier element disposed within the central chamber of the tank, wherein a cross-section of an article is formed on both sides of the carrier element when the first emitting device moves step-wise in tandem with the first moveable partition then emits a blast and the second emitting device moves step-wise in tandem with the second moveable partition then emits a blast.

6. The stereolithography system as claimed in claim 5 wherein the carrier element is an absorbent carrier element.

7. The stereolithography system as claimed in claim 5 wherein the carrier element is a non-absorbent carrier element.

8. The stereolithography system as claimed in claim 1 further including a smaller tank within the tank.

9. The stereolithography system as claimed in claim 1 wherein the tank has removable side walls.

10. The stereolithography system as claimed in claim 1 further including a tank cover which blocks extraneous UV light.

11. The stereolithography system as claimed in claim 1 wherein the tank is coated in polytetrafluoroethylene.

12. The stereolithography system as claimed in claim 1 wherein the first emitting device, the second emitting device, and the tank are generally aligned horizontally.

13. The stereolithography system as claimed in claim 1 wherein the first emitting device, the second emitting device, and the tank are generally aligned vertically.

14. A stereolithography system comprising:
a moveable emitting device;
a tank including a first partition and a second partition which define a central chamber of the tank, the second partition being moveable; and
a drip feeder in fluid communication with and providing resin to the central chamber of the tank, wherein a cross-section of an article is formed on an inner side of the first partition as the moveable emitting device moves step-wise with the second moveable partition then emits a blast.

15. The stereolithography system as claimed in claim 14 wherein the second emitting device moves step-wise in tandem with the second moveable partition.

16. The stereolithography system as claimed in claim 14 wherein the second emitting device moves step-wise independently of the second moveable partition.
